(19) United States
(12) Patent Application Publication
(10) Pub. No.: US 2010/0116642 A1
(43) Pub. Date: May 13, 2010

(54) Method For Producing Alkaline Fatty Acid Amides

(75) Inventors: Matthias Krull, Harxheim (DE); Roman Morschhaeuser, Mainz (DE); Christoph Kayser, Mainz (DE); Helmut Ritter, Wuppertal (DE); Sarah Schmitz, Duesseldorf (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Finance (BVI) Limited, Tortola (VG)

(21) Appl. No.: 12/444,643

(22) PCT Filed: Oct. 5, 2007
(86) PCT No.: PCT/EP07/08680

§ 371 Date: Jun. 2, 2009

(30) Foreign Application Priority Data
Oct. 9, 2006 (DE) 10 2006 047 619.0

(51) Int. Cl. B01J 19/12

(52) U.S. Cl. 204/157.82

(57) ABSTRACT

The invention relates to a method for producing alkaline fatty acid amides by reacting at least one amine that contains at least one primary or secondary amino group and at least one tertiary amino group with at least one fatty acid to form an ammonium salt, said ammonium salt being subsequently converted into the alkaline amide by means of microwave radiation.

Fatty acid derivatives which bear functional groups with basic character are sought-after as precursors for producing surface-active substances. By reaction with alkylating agents, they can be converted to cationic surfactants. By reaction with alkylating agents bearing acid groups, so-called betaines are obtainable therefrom; oxidation reactions with peroxides lead to the group of the amine oxides, a product group which is likewise considered to be amphoteric. Amine oxides and betaines find wide use as raw materials for the production of washing compositions, cleaning concentrates, detergents, cosmetics and pharmaceuticals, as emulsifiers, and in the mineral oil industry as corrosion or gas hydrate inhibitors.

Of particular interest are especially those fatty acid derivatives which bear an alkyl radical which is bonded via an amide group and is in turn substituted by at least one tertiary amino group which imparts basic character. Such amides have greatly increased hydrolysis stability compared to corresponding esters. Basic fatty acid amides are typically used in abovementioned applications after further conversion, for example to quaternary ammonium compounds, N-oxides or else betaines.

In order to cover the growing demand for existing and new applications, various methods have been developed for the preparation of fatty acid amides bearing tertiary amino groups. The preparation of such basic amides has to date relied on costly and/or laborious preparation processes in order to achieve a yield of commercial interest. The known preparation processes require activated carboxylic acid derivatives, for example acid anhydrides, acid halides such as acid chlorides or esters, or an in situ activation by the use of coupling reagents, for example N,N′-dicyclohexylcarbodiimide. Some of these preparation processes form large amounts of undesired by-products such as alcohols, acids and salts, which have to be removed from the product and disposed of. However, the residues of these auxiliary products and by-products which remain in the products can also cause some very undesired effects. For example, halide ions, and also acids, lead to corrosion; some coupling reagents and some of the by-products formed by them are toxic, sensitizing or else carcinogenic.

The direct thermal condensation of carboxylic acid and diamine does not lead to satisfactory results, since various side reactions reduce the yield. Examples include decarboxylation of the carboxylic acid, oxidation of the amino group during the long heating required to achieve high conversions, and especially the thermally induced degradation of the tertiary amino group. Since such side reactions lead, among other results, to the formation of reactive C═C double bonds, it is possible in this way for both the amine used and the amides once they have formed to give rise to compounds with polymerizable sites which lead to undesired polymer formation and other side reactions. For example, N-[3-(N,N-dimethylamino)propyl] fatty acid amides in the presence of acids can give rise to N-(allyl) fatty acid amides by Hofmann degradation. Side reactions additionally lead to colored by-products, and as a result it is impossible to prepare colorless products with iodine color numbers of, for example, less than 6, which are desired especially for cosmetic applications. The latter requires either the use of color-improving additives during the thermal amidation reaction and/or additional process steps, for example bleaching, but this in turn requires the addition of further assistants and often leads to a likewise undesired impairment of the odor of the amides.

Goretzki et al., Macromol. Rapid Commun. 2004, 25, 513-516 discloses the microwave-supported synthesis of various (meth)acrylamides directly from (meth)acrylic acid and amine. Various aliphatic and aromatic amines are used.

Gelens et al., Tetrahedron Letters 2005, 46(21), 3751-3754 discloses a multitude of amides which have been synthesized with the aid of microwave radiation. However, none contains an additional tertiary amino group.

Consequently, a process has been sought for preparing basic fatty acid amides, in which fatty acids and amines bearing tertiary amino groups can be converted directly and in high, i.e. up to quantitative, yields to fatty acid amides bearing tertiary amino groups. In addition, only minor amounts of by-products, if any, such as, more particularly, ethylenically unsaturated compounds and conversion products thereof should occur. In addition, basic fatty acid amides with a minimum level of intrinsic coloration should form.

It has been found that fatty acid amides bearing tertiary amino groups can be prepared in high yields by directly reacting at least one primary or secondary amino group and polyamines bearing at least one tertiary amino group with fatty acids by irradiating with microwaves. Surprisingly, in spite of the presence of acids, no significant side reactions and more particularly no Hofmann elimination of the tertiary amino group occurs. In addition, the fatty acid amides thus prepared have a low level of intrinsic coloration which is not obtainable compared to conventional preparation processes without additional process steps.

The invention provides a process for preparing basic fatty acid amides by reacting at least one amine which contains at least one primary or secondary amino group and at least one tertiary amino group with at least one fatty acid to give an ammonium salt, and then converting this ammonium salt further under microwave irradiation to the basic amide.

The invention further provides basic fatty acid amides preparable by reacting at least one amine which contains at least one primary or secondary amino group and at least one tertiary amino group with at least one fatty acid to give an ammonium salt, and then converting this ammonium salt further under microwave irradiation to the basic amide.

The invention further provides basic fatty acid amides which have iodine color numbers of less than 5, preparable by reacting at least one amine which contains at least one primary or secondary amino group and at least one tertiary amino group with at least one fatty acid to give an ammonium salt, and then converting this ammonium salt further under microwave irradiation to the basic amide.

The invention further provides basic fatty acid amides which are free of halide ions and by-products originating from coupling reagents, preparable by reacting at least one amine which contains at least one primary or secondary amino group and at least one tertiary amino group with at least one fatty acid to give an ammonium salt, and then converting this ammonium salt further under microwave irradiation to the basic amide.

Basic amides are understood to mean amides whose amide nitrogen atom bears at least one hydrocarbon radical substituted by at least one tertiary amino group. In the context of the present invention, tertiary amino groups are structural units in which a nitrogen atom does not bear an acidic proton. For instance, the nitrogen of the tertiary amino group may bear three hydrocarbon radicals or else be part of a heteroaromatic system. Fatty acid amides free of halide ions do not contain any amounts of these ions over and above the ubiquitous amounts of halide ions.

Fatty acids are preferably understood to mean carboxylic acids which bear a hydrocarbon radical having 1 to 50 carbon atoms. Preferred fatty acids have 6 to 50, in particular 8 to 30 and especially 10 to 24 carbon atoms, for example 12 to 18 carbon atoms. They may be of natural or synthetic origin. They may bear substituents, for example halogen atoms, halogenated alkyl radicals, or cyano, hydroxyalkyl, hydroxyl, methoxy, nitrile, nitro and/or sulfonic acid groups. Particular preference is given to aliphatic hydrocarbon radicals. These aliphatic hydrocarbon radicals may be linear, branched or cyclic, and saturated or unsaturated. When they are unsaturated, they may contain one or more, for example two, three or more, double bonds. Preferably, no double bond is in the α,β position to the carboxyl group. Suitable fatty acids are, for example, octanoic acid, decanoic acid, dodecanoic acid, tridecanoic acid, tetradecanoic acid, 12-methyltridecanoic acid, pentadecanoic acid, 13-methyltetradecanoic acid, 12-methyltetradecanoic acid, hexadecanoic acid, 14-methylpentadecanoic acid, heptadecanoic acid, 15-methylhexadecanoic acid, 14-methylhexadecanoic acid, octadecanoic acid, isooctadecanoic acid, eicosanoic acid, docosanoic acid and tetracosanoic acid, and myristoleic acid, palmitoleic acid, hexadecadienoic acid, delta-9-cis-heptadecenoic acid, oleic acid, petroselic acid, vaccenic acid, linoleic acid, linolenic acid, gadoleic acid, gondoleic acid, eicosadienoic acid, arachidonic acid, cetoleic acid, erucic acid, docosadienoic acid and tetracosenoic acid, and also ricinoleic acid. Additionally suitable are fatty acid mixtures obtained from natural fats and oils, for example cottonseed oil, coconut oil, peanut oil, safflower oil, corn oil, palm kernel oil, rapeseed oil, castor oil, olive oil, mustardseed oil, soybean oil, sunflower oil, and tallow oil, bone oil and fish oil. Likewise suitable as fatty acids or fatty acid mixtures for the process according to the invention are tall oil fatty acid, and resin acids and naphthenic acids.

Amines suitable in accordance with the invention possess two or more amino groups. At least one of these amino groups is tertiary, which means that it bears three alkyl radicals or is part of a heteroaromatic system. In addition, at least one of these amino groups is a primary or secondary amino group, i.e. bears at least one amino group or two hydrogen atoms. This amino group is preferably a primary amino group, i.e. it bears two hydrogen atoms. In a further preferred embodiment, the amine suitable in accordance with the invention contains three or more amino groups, of which at least one is primary, at least one secondary and at least one is tertiary. Preferred amines correspond to the formula

HNR¹-(A)ₙ-Z

in which
R¹ is hydrogen, C₁-C₁₂-alkyl, C₅-C₁₂-cycloalkyl, C₆-C₁₂-aryl, C₇-C₁₂-aralkyl or a heteroaromatic group having 5 to 12 ring members,
A is a divalent hydrocarbon radical having 2 to 50 carbon atoms,
n is 0 or 1,
Z is a group of the formula —NR²R³ or a nitrogen-containing cyclic hydrocarbon radical having at least 5 ring members and
R², R³ are each independently C₁- to C₂₀-hydrocarbon radicals.

R¹ is preferably hydrogen or methyl, especially hydrogen.

A is preferably an alkylene radical having 2 to 50 carbon atoms, a cycloalkylene radical having 5 to 12 ring members, an arylene radical having 6 to 12 ring members or a heteroarylene radical having 5 to 12 ring members. A is more preferably an alkylene radical having 2 to 12 carbon atoms. n is preferably 1. More preferably, A is a linear or branched alkylene radical having 1 to 12 carbon atoms and n is 1.

More preferably, when Z is a group of the formula —NR²R³, A is a linear or branched alkylene radical having 2, 3 or 4 carbon atoms, especially an ethylene radical or a linear propylene radical. When Z, in contrast, is a nitrogen-containing cyclic hydrocarbon radical, particular preference is given to compounds in which A is a linear alkylene radical having 1, 2 or 3 carbon atoms, especially a methylene, ethylene or a linear propylene radical.

Cyclic radicals preferred for the structural element A may be mono- or polycyclic and, for example, contain two or three ring systems. Preferred ring systems possess 5, 6 or 7 ring members. They preferably contain a total of about 5 to 20 carbon atoms, especially 6 to 10 carbon atoms. Preferred ring systems are aromatic and contain only carbon atoms. In a specific embodiment, the structural elements A are formed from arylene radicals. The structural element A may bear substituents, for example alkyl radicals, halogen atoms, halogenated alkyl radicals, or nitro, cyano, nitrile, hydroxyl and/or hydroxyalkyl groups. When A is a monocytic aromatic hydrocarbon, the amino groups or substituents bearing amino groups are preferably in ortho or para positions to one another.

Z is preferably a group of the formula —NR²R³. In this formula, R² and R³ are each independently preferably aliphatic, aromatic and/or araliphatic hydrocarbon radicals having from 1 to 20 carbon atoms. Particularly preferred R² and R³ are alkyl radicals. When R² and/or R³ are alkyl radicals, they bear preferably 1 to 14 carbon atoms, for example 1 to 6 carbon atoms. These alkyl radicals may be linear, branched and/or cyclic. More preferably, R² and R³ are each alkyl radicals having from 1 to 4 carbon atoms, for example methyl, ethyl, n-propyl, isopropyl, n-butyl and isobutyl.

The R² and R³ radicals may be substituted by heteroatoms, for example O and/or S, and/or bear substituents containing such heteroatoms. However, they preferably do not contain more than 1 heteroatom per 2 carbon atoms. Thus, in a further preferred embodiment, R² and/or R³ are each independently polyoxyalkylene radicals of the formula

—(B—O)ₘ—R⁴

in which
B is a linear or branched C₂-C₄-alkylene radical, especially a group of the formula —CH₂—CH₂— and/or —CH(CH₃)—CH₂—,
m is from 1 to 100, preferably 2 to 20, and
R⁴ is hydrogen, an alkyl radical having 1 to 20 carbon atoms, a cycloalkyl radical having 5 to 12 ring atoms, an aryl radical having 6 to 12 ring atoms, an aralkyl radical having 7 to 30 carbon atoms, a heteroaryl radical having 5 to 12 ring atoms or a heteroaralkyl radical having 6 to 12 carbon atoms.

Aromatic radicals particularly suitable as R² and/or R³ include ring systems with at least 5 ring members. They may contain heteroatoms such as S, O and N. Araliphatic radicals particularly suitable as R² and/or R³ include ring systems with at least 5 ring members which are bonded to the nitrogen via a C₁-C₆-alkyl radical. They may contain heteroatoms such as S, O and N. The aromatic and also the araliphatic radicals may bear further substituents, for example alkyl radicals, halogen atoms, halogenated alkyl radicals, or nitro, cyano, nitrile, hydroxyl and/or hydroxyalkyl groups.

In a further preferred embodiment, Z is a nitrogen-containing cyclic hydrocarbon radical whose nitrogen atom is incapable of forming amides. The cyclic system may be monocyclic, bicyclic or else polycyclic. It preferably contains one or more five- and/or six-membered rings. This cyclic hydrocarbon may contain one or more, for example two or three, nitrogen atoms which do not bear any acidic protons; more preferably, it contains one nitrogen atom. Particularly suitable are nitrogen-containing aromatics whose nitrogen is involved in the formation of an aromatic π-electron sextet, for example pyridine. Likewise suitable are nitrogen-containing heteroaliphatics whose nitrogen atoms do not bear any protons and, for example, are all saturated with alkyl radicals. Z is joined to A or to the group of the formula NHR¹ (if n=0) here preferably via a nitrogen atom of the heterocycle, as, for example, in the case of 1-(3-aminopropyl)pyrrolidine. The cyclic hydrocarbon represented by Z may bear further substituents, for example C₁-C₂₀-alkyl radicals, halogen atoms, halogenated alkyl radicals, or nitro, cyano, nitrile, hydroxyl and/or hydroxyalkyl groups.

Examples of amines suitable in accordance with the invention are N,N-dimethyl-ethylenediamine, N,N-dimethyl-1,3-propanediamine, N,N-diethyl-1,3-propane-diamine, N,N-dimethyl-2-methyl-1,3-propanediamine, N,N-(2″-hydroxyethyl)-1,3-propanediamine, 1-(3-aminopropyl)pyrrolidine, 1-(3-aminopropyl)-4-methyl-piperazine, 3-(4-morpholino)-1-propylamine, 2-aminothiazole, the various isomers of N,N-dimethylaminoaniline, of aminopyridine, of aminomethylpyridine, of amino-methylpiperidine and of aminoquinoline, and also 2-aminopyrimidine, 3-amino-pyrazole, aminopyrazine and 3-amino-1,2,4-triazole.

The process is especially suitable for preparing N—(N′,N′-dimethylamino)propyl-dodecanamide, N—(N′,N′-dimethylamino)propyl coconut fatty acid amide, N—(N′,N′-dimethylamino)propyl tallow fatty acid amide, N—(N′,N′-dimethylamino)-ethyl coconut fatty acid amide and N—(N′,N′-dimethylamino)propyl palm fatty acid amide.

In the process according to the invention, fatty acid and amine can be reacted with one another in any desired ratios. The reaction is preferably effected with molar ratios between fatty acid and amine of 10:1 to 1:10, preferably of 2:1 to 1:2, especially of 1:1.2 to 1.2:1 and more particularly equimolar.

In many cases, it has been found to be advantageous to work with a small excess of amine, i.e. molar ratios of amine to fatty acid of at least 1.01:1.00 and especially between 1.02:1.00 and 1.3:1.0, for example between 1.05:1.0 and 1.1:1. This converts the fatty acid virtually quantitatively to the basic amide. This process is particularly advantageous when the amine used, which bears at least one primary and/or secondary and at least one tertiary amino group, is volatile. “Volatile” here means that the amine has a boiling point at standard pressure of preferably below 200° C., for example below 150° C., and can thus be removed from the amide by distillation.

The inventive preparation of the amides is effected by reacting the fatty acid and the amine to give the ammonium salt and subsequently irradiating the salt with microwaves. The ammonium salt is preferably obtained in situ and not isolated. Preferably, the temperature rise caused by the microwave irradiation is limited to a maximum of 300° C. by regulating the microwave intensity and/or cooling the reaction vessel. It has been found to be particularly useful to perform the reaction at temperatures between 100 and not more than 250° C. and especially between 120 and not more than 200° C., for example at temperatures between 125 and 190° C.

The duration of the microwave irradiation depends on various factors, such as the reaction volume, the geometry of the reaction chamber and the desired conversion. Typically, the microwave irradiation is undertaken over a period of less than 30 minutes, preferably between 0.01 second and 15 minutes, more preferably between 0.1 second and 10 minutes and especially between one second and 5 minutes, for example between 5 seconds and 2 minutes. The intensity (power) of the microwave radiation is adjusted such that the reaction mixture reaches the desired reaction temperature within a very short time. To subsequently maintain the temperature, the reaction mixture can be irradiated further with reduced and/or pulsed power. To maintain the maximum temperature with simultaneously maximum possible microwave irradiation, it has been found to be useful to cool the reaction mixture, for example by means of cooling jackets, cooling tubes present in the reaction chamber, by intermittent cooling between different irradiation zones and/or by evaporative cooling using external heat exchangers. In a preferred embodiment, the reaction product, directly after the microwave irradiation has ended, is cooled very rapidly to temperatures below 120° C., preferably below 100° C. and especially below 60° C.

The reaction is performed preferably at pressures between 0.01 and 200 bar and especially between 1 bar (atmospheric pressure) and 50 bar. It has been found to be particularly useful to work in closed vessels in which operation is effected above the boiling point of the reactants or products, of any solvent used and/or above the water of reaction formed during the reaction. Typically, the pressure which is established owing to the heating of the reaction mixture is sufficient for successful performance of the process according to the invention. However, it is also possible to work under elevated pressure and/or with application of a pressure profile. In a further preferred variant of the process according to the invention, operation is effected under atmospheric pressure as established, for example, in an open vessel.

To prevent side reactions and to prepare very pure products, it has been found to be useful to perform the process according to the invention in the presence of an inert protective gas, for example nitrogen, argon or helium.

In a preferred embodiment, the reaction is accelerated or completed by working in the presence of dehydrating catalysts. Preference is given to working in the presence of an acidic inorganic, organometallic or organic catalyst, or mixtures of a plurality of these catalysts.

Acidic inorganic catalysts in the context of the present invention include, for example, sulfuric acid, phosphoric acid, phosphoric acid, hypophosphorous acid, aluminum sulfate hydrate, alum, acidic silica and acidic aluminum hydroxide. Also usable as acidic inorganic catalysts are, for example, aluminum compounds of the formula Al(OR⁵)₃ and titanates of the formula Ti(OR⁵)₄, where the R⁵ radicals may each be the same or different and are independently selected from C₁-C₁₀-alkyl radicals, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, sec-hexyl, n-heptyl, n-octyl, 2-ethylhexyl, n-nonyl or n-decyl, C₃-C₁₂-cycloalkyl radicals, for example cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl. The R⁵ radicals in Al(OR⁵)₃ or Ti(OR⁵)₄ are preferably each the same and are selected from isopropyl, butyl and 2-ethylhexyl.

Preferred acidic organometallic catalysts are, for example, selected from dialkyltin oxides (R⁵)₂SnO where R⁵ is as defined above. A particularly preferred representative of acidic organometallic catalysts is di-n-butyltin oxide, which is commercially available as so-called oxo-tin or as Fascat® brands.

Preferred acidic organic catalysts are acidic organic compounds with, for example, phosphate groups, sulfonic acid groups, sulfate groups or phosphonic acid groups.

Particularly preferred sulfonic acids contain at least one sulfonic acid group and at least one saturated or unsaturated, linear, branched and/or cyclic hydrocarbon radical having from 1 to 40 carbon atoms and preferably having from 3 to 24 carbon atoms. Especially preferred are aromatic sulfonic acids, especially alkylaromatic monosulfonic acids having one or more C₁-C₂₈-alkyl radicals and especially those having C₃-C₂₂-alkyl radicals. Suitable examples are methanesulfonic acid, butanesulfonic acid, benzenesulfonic acid, p-toluenesulfonic acid, xylenesulfonic acid, 2-mesitylenesulfonic acid, 4-ethylbenzenesulfonic acid, isopropylbenzenesulfonic acid, 4-butylbenzenesulfonic acid, 4-octylbenzene-sulfonic acid; dodecylbenzenesulfonic acid, didodecylbenzenesulfonic acid, naphthalenesulfonic acid. It is also possible to use acidic ionic exchangers as acidic organic catalysts, for example sulfo-containing poly(styrene) resins crosslinked with about 2 mol % of divinylbenzene.

For the performance of the process according to the invention, particular preference is given to boric acid, phosphoric acid, polyphosphoric acid and polystyrenesulfonic acids. Especially preferred are titanates of the formula Ti(OR⁵)₄ and especially titanium tetrabutoxide and titanium tetraisopropoxide.

If the use of acidic inorganic, organometallic or organic catalysts is desired, 0.01 to 10% by weight, preferably 0.02 to 2% by weight, of catalyst is used in accordance with the invention. In a particularly preferred embodiment, no catalyst is employed. In a further preferred embodiment, the microwave irradiation is performed in the presence of acidic solid catalysts. In this case, the solid catalyst is suspended in the ammonium salt which may have been admixed with solvent or, in continuous processes, the ammonium salt which may have been admixed with solvent is advantageously passed over a fixed catalyst bed and exposed to microwave radiation. Suitable solid catalysts are, for example, zeolites, silica gel, montmorillonite and (partly) crosslinked polystyrenesulfonic acid, which may optionally be impregnated with catalytically active metal salts. Suitable acidic ion exchangers based on polystyrenesulfonic acids, which can be used as solid phase catalysts, are obtainable, for example, from Rohm & Haas under the Amberlyst® brand.

It has been found to be useful to work in the presence of solvents, in order, for example, to lower the viscosity of the reaction medium, to fluidize the reaction mixture, if it is heterogeneous, and/or to improve the removal of heat, for example by means of evaporative cooling. For this purpose, it is possible in principle to use all solvents which are inert under the reaction conditions employed and do not react with the reactants or the products formed. An important factor in the selection of suitable solvents is their polarity, which first determines the dissolution properties and secondly the extent of interaction with microwave radiation. A particularly important factor in the selection of suitable solvents is their dielectric loss ∈″. The dielectric loss ∈″ describes the proportion of microwave radiation which is converted to heat on interaction of a substance with microwave radiation. The latter value has been found to be a particularly important criterion for the suitability of a solvent for the performance of the process according to the invention. It has been found to be particularly useful to work in solvents which exhibit a minimum microwave absorption and hence make only a small contribution to the heating of the reaction system. Solvents preferred for the process according to the invention possess a dielectric loss ∈″, measured at room temperature and 2450 MHz, of less than 10 and preferably less than 1, for example less than 0.5. An overview of the dielectric loss of various solvents can be found, for example, in “Microwave Synthesis” by B. L. Hayes, CEM Publishing 2002. Especially suitable for the process according to the invention are solvents with ∈″ values below 10, such as N-methylpyrrolidone, N,N-dimethylformamide or acetone, and especially solvents having ∈″ values below 1. Examples of particularly preferred solvents with ∈″ values below 1 are aromatic and/or aliphatic hydrocarbons, for example toluene, xylene, ethylbenzene, tetralin, hexane, cyclohexane, decane, pentadecane, decalin and commercial hydrocarbon mixtures such as petroleum fractions, kerosene, solvent naphtha, ®Shellsol AB, ®Solvesso 150, ®Solvesso 200, ®Exxsol, ®Isopar and ®Shellsol types. Solvent mixtures which have ∈″ values preferably below 10 and especially below 1 are equally preferred for the performance of the process according to the invention. In principle, the process according to the invention is also possible in solvents with ∈″ values of 10 and higher, but this requires special measures for maintaining the maximum temperature and often leads to reduced yields. When working in the presence of solvents, the proportion thereof in the reaction mixture is preferably between 2 and 95% by weight, especially between 5 and 90% by weight and more particularly between 10 and 75% by weight, for example between 30 and 60% by weight. The reaction is more preferably performed without solvent.

The microwave irradiation is typically performed in units which possess a reaction chamber composed of a material very substantially transparent to microwaves, into which microwave radiation generated in a microwave generator is injected by means of suitable antenna systems. Microwave generators, for example the magnetron and the klystron, are known to those skilled in the art.

Microwaves refer to electromagnetic rays having a wavelength between about 1 cm and 1 m and frequencies between about 300 MHz and 30 GHz. This frequency range is suitable in principle for the process according to the invention. Preference is given to using, for the process according to the invention, microwave radiation with the frequencies approved for industrial, scientific and medical applications of 915 MHz, 2.45 GHz, 5.8 GHz or 27.12 GHz. It is possible to work either in monomode or quasi-monomode, or else in multimode. In the case of monomode, which places high demands on the geometry and size of apparatus and reaction chamber, a very high energy density is generated by a standing wave, especially at the maximum thereof. In multimode, in contrast, the entire reaction chamber is irradiated substantially homogeneously, which enables, for example, greater reaction volumes.

The microwave power to be injected into the reaction vessel for the performance of the process according to the invention is dependent especially on the geometry of the reaction chamber and hence on the reaction volume, and on the duration of the irradiation required. It is typically between 100 W and several hundred kW, and especially between 200 W and 100 kW, for example between 500 W and 70 kW. It can be applied at one or more sites in the reactor. It can be generated by means of one or more microwave generators.

The reaction can be carried out batchwise or preferably continuously in a flow tube, for example. It can additionally be performed in semibatchwise processes, for example continuous stirred reactors or cascade reactors. In a preferred embodiment, the reaction is performed in a closed vessel, in which case the condensate which forms and if appropriate reactants and, where present, solvents lead to a pressure buildup. After the reaction has ended, the elevated pressure can be used by decompression to volatilize and remove water of reaction, and if appropriate solvents and excess reactants, and/or cool the reaction product. In a further embodiment, the water of reaction formed, after cooling and/or decompression, is removed by customary processes, for example phase separation, distillation and/or absorption. The process according to the invention can be effected equally successfully in an open vessel with evaporative cooling and/or separation of the water of reaction.

In a preferred embodiment, the process according to the invention is performed in a batchwise microwave reactor. The microwave irradiation is undertaken in a stirred vessel. To remove excess heat, cooling elements are preferably present in the reaction vessel, for example cooling fingers or cooling coils, or reflux condensers flanged onto the reaction vessel for evaporative cooling of the reaction medium. For the irradiation of relatively large reaction volumes, the microwave here is preferably operated in multimode. The batchwise embodiment of the process according to the invention allows, through variation of the microwave power, rapid or else slow heating rates, and especially the maintenance of the temperature over prolonged periods, for example several hours. The reactants and any solvents and further assistants can be initially be charged in the reaction vessel before commencement of the microwave irradiation. They preferably have temperatures below 100° C., for example between 10° C. and 50° C. In a further embodiment, the reactants or portions thereof are not added to the reaction vessel until during the irradiation with microwaves. In a further preferred embodiment, the batchwise microwave reactor is operated with continuous supply of reactants and simultaneous discharge of reaction mixture in the form of a semibatchwise or cascade reactor.

In a particularly preferred embodiment, the process according to the invention is performed in a continuous microwave reactor. To this end, the reaction mixture is conducted through a pressure-resistant reaction tube which is inert toward the reactants, is very substantially transparent to microwaves and is installed into a microwave oven. This reaction tube preferably has a diameter of from one millimeter to approx. 50 cm, especially between 2 mm and 35 cm, for example between 5 mm and 15 cm. Reaction tubes are understood here to mean vessels whose ratio of length to diameter is greater than 5, preferably between 10 and 100 000, more preferably between 20 and 10 000, for example between 30 and 1000. In a specific embodiment, the reaction tube is configured in the form of a jacketed tube through whose interior and exterior the reaction mixture can be conducted successively in countercurrent, in order, for example, to increase the thermal conduction and energy efficiency of the process. The length of the reaction tube is understood to mean the total distance through which the reaction mixture flows. Over its length, the reaction tube is surrounded by at least one microwave radiator, but preferably more than one, for example two, three, four, five, six, seven, eight or more microwave radiators. The microwaves are preferably injected through the tube jacket. In a further preferred embodiment, the microwaves are injected by means of at least one antenna via the tube ends. The reaction tube is typically provided at the inlet with a metering pump and a manometer, and at the outlet with a pressure-retaining valve and a heat exchanger. The amine and fatty acid reactants, both independently optionally diluted with solvent, are preferably not mixed until shortly before entry into the reaction tube. Additionally preferably, the reactants are supplied to the process according to the invention in liquid form with temperatures below 100° C. and preferably between 10 and 95° C., for example between 20° C. and 50° C. To this end, higher-melting reactants can be used, for example, in the molten state or admixed with solvent. A catalyst can, if used, be added to one of the reactants or else to the reactant mixture before entry into the reaction tube.

Variation of tube cross section, length of the irradiation zone (this is understood to mean the proportion of the reaction tube in which the reaction mixture is exposed to microwave irradiation), flow rate, geometry of the microwave radiators, the microwave power injected and the temperature attained as a result are used to adjust the reaction conditions such that the maximum reaction temperature is attained as rapidly as possible and the residence time at maximum temperature remains sufficiently short that as low as possible a level of side reactions or further reactions occurs. Preference is given to operating the continuous microwave reactor in monomode or quasi-monomode. The residence time in the reaction tube is generally less than 30 minutes, preferably between 0.01 second and 15 minutes and more preferably between 0.1 second and 5 minutes, for example between one second and 3 minutes. To complete the reaction, if appropriate after intermediate cooling, the reaction mixture can pass through the reactor more than once. It has been found to be particularly useful when the reaction product, immediately after leaving the reaction tube, is cooled, for example by jacket cooling or decompression.

It was particularly surprising that, in spite of the only very short residence time of the ammonium salt in the microwave field in the flow tube with continuous flow, such a substantial amidation takes place without formation of significant amounts of by-products. In the case of a corresponding reaction of these ammonium salts in a flow tube with thermal jacket heating, in contrast, only low conversions to the amide are achieved. At the same time, however, the extremely high wall temperatures required to achieve suitable reaction temperatures cause a considerable degree of decomposition reactions of the diamine and the formation of colored species to be observed.

To complete the reaction, it has been found to be useful in many cases to expose the resulting crude product, after removal of water of reaction and optionally discharging product and/or by-product, again to microwave irradiation.

Typically, amides prepared via the inventive route are obtained in a purity sufficient for further use. For specific requirements, they can, however, be purified further by customary purification processes such as distillation, recrystallization, filtration, or via chromatographic processes.

The basic amides prepared in accordance with the invention are suitable, for example, for preparing cationic compounds and especially for preparing zwitterionic compounds. For instance, quaternization with alkyl halides, for example methyl iodide, methyl bromide, methyl chloride, benzyl bromide, benzyl chloride or dimethyl sulfate, leads to quaternary cationic structures. Oxyalkylating quaternization also allows the basic amides prepared in accordance with the invention to be converted to cationic compounds. By reaction with alkylating agents bearing acidic groups, it is possible to obtain zwitterionic structures (betaines). Examples of suitable alkylating agents bearing acidic groups are haloacetic acids or salts thereof, such as chloroacetic acid, haloalkanesulfonic acids or salts thereof, such as bromoethanesulfonic acid, and cyclic sulfolanes. The oxidation of the tertiary nitrogen, for example with peroxides such as H₂O₂, leads to N-oxides. All these structures are surface-active and find various industrial uses, for example as a raw material for the production of washing compositions, cleaning concentrates, detergents, cosmetics and pharmaceuticals, as emulsifiers, and in the mineral oil industry as corrosion or gas hydrate inhibitors.

The process according to the invention allows very rapid and inexpensive preparation of basic fatty acid amides in high yields and with high purity. The intrinsic coloration, measured as the iodine color number to DIN 6162, of the amides (concentrates) thus prepared is less than 5 and often less than 4, for example below 3.5. At the same time, no significant amounts of by-products are obtained. Such rapid and selective reactions are unachievable by conventional methods and were also not to be expected solely through heating to high temperatures. Since the basic amides prepared by the process according to the invention and the compounds derived therefrom additionally, as a result of the process, do not contain any residues of coupling reagents or conversion products thereof, they can be used without any problem even in toxicologically sensitive areas, for example cosmetic and pharmaceutical formulations. In the selection of suitable quaternizing agents, it is likewise possible to provide betaines free of halide ions, which lead to corrosion.

### EXAMPLES

The reactions under microwave irradiation were effected in a CEM “Discover” single-mode microwave reactor at a frequency of 2.45 GHz. The reaction vessels were cooled by means of compressed air. The temperature was measured by means of an IR sensor at the base of the cuvette. Owing to the pressure conditions in the reaction vessel, the temperatures had to be measured by means of an IR sensor at the base of the cuvette. Comparative tests with a glass fiber optic immersed into the reaction mixture found that the temperature in the reaction medium, within the temperature range relevant here, is about 50 to 80° C. above the temperature measured with the IR sensor at the base of the cuvette.

The batchwise reactions were effected in closed, pressure-resistant glass cuvettes with a volume of 8 ml with magnet stirring. Continuous reactions were effected in pressure-resistant, cylindrical glass cuvettes configured as a jacketed tube (approx. 10×1.5 cm; reaction volume approx. 15 ml) with an internal inlet tube ending above the base of the cuvette, and product removal at the upper end of the cuvette. The pressure which builds up during the reaction was limited to a maximum of 20 bar by means of a pressure-retaining valve and released into a reservoir. The ammonium salt was pumped into the cuvette through the inlet tube, and the residence time in the irradiation zone was adjusted by modifying the pump output.

The products were analyzed by means of ¹H NMR spectroscopy at 500 MHz in CDCl₃. Water determinations were effected by means of Karl-Fischer titration. The iodine color number was determined to DIN 6162.

### Example 1

### Preparation of N-(3-(N,N-Dimethylamino)Propyl)Capronamide

While cooling and stirring, 1 g of N,N-dimethylaminopropylamine was admixed slowly with an equimolar amount of caproic acid. After the exothermicity had abated, the ammonium salt thus obtained was exposed in a closed cuvette to microwave irradiation of 100 W with maximum cooling performance for 1 minute. A temperature of 195° C. measured by means of an IR sensor was attained. The pressure which builds up during the reaction reached 15 bar.

The resulting crude product contained, as main components, 88% N-(3-(N,N-dimethylamino)propyl)capronamide, 7% water and unconverted reactants. After the reaction mixture had been dried over molecular sieve, irradiated with 100 W microwaves again for 1 minute and dried over molecular sieve, N-(3-(N,N-dimethylamino)propyl)capronamide was obtained with more than 95% yield. The iodine color number was 3.0.

### Example 2

### Preparation of N-(3-(N,N-Dimethylamino)Propyl)Laurylamide

At 50° C., 1.1 g of N,N-dimethylaminopropylamine was admixed slowly with 2.0 g of lauric acid with stirring. After the exothermicity had abated, the ammonium salt thus obtained was exposed in a closed cuvette to microwave irradiation of 150 W with maximum cooling performance for 1 minute. A temperature of 150° C. measured by means of an IR sensor was attained, and the pressure rose to 3.5 bar.

The crude product contained, as the main component, 90% N-(3-(N,N-dimethyl-amino)propyl)laurylamide and 5% water and unconverted reactants. After the reaction mixture had been dried over molecular sieve, irradiated with 100 W microwaves again for 1 minute and dried over molecular sieve, N-(3-(N,N-dimethylamino)propyl)laurylamide was obtained with more than 96% yield. The iodine color number was 1.8.

### Example 3

### Preparation of N-(3-(N,N-Dimethylamino)Propyl)Caprylamide

With cooling and stirring, 1 g of N,N-dimethylaminopropylamine was admixed slowly with an equimolar amount of caprylic acid. After the exothermicity had abated, the ammonium salt thus obtained was exposed in a closed cuvette to microwave irradiation of 100 W with maximum cooling performance for 1 minute. A temperature of 200° C. measured by means of an IR sensor was attained, and the pressure rose to about 4 bar.

The crude product contained, as the main component, 64% N-(3-(N,N-dimethyl-amino)propyl)caprylamide, 7% water and unconverted reactants. After the reaction mixture had been dried over molecular sieve, irradiated with 100 W microwaves again for 1 minute and dried over molecular sieve, N-(3-(N,N-dimethylamino)-propyl)octylamide was obtained with more than 94% yield. The iodine color number was 2.2.

### Example 4

### Continuous Preparation of N-(3-(N,N-Dimethylamino)Propyl)-Caprylamide

With cooling and stirring, a mixture of 107 g (1.05 mol) of N,N-dimethylamino-propylamine and 100 g of xylene was admixed slowly with 144 g (1 mol) of caprylic acid. After the exothermicity had abated, the ammonium salt thus obtained was pumped continuously via the bottom inlet through the glass cuvette mounted in the microwave cavity. The delivery output of the pump was adjusted such that the residence time in the cuvette and hence in the irradiation zone was about 50 seconds. Maximum cooling performance was employed with a microwave power of 200 W, and a temperature of 190° C. measured by means of an IR sensor was attained. After leaving the glass cuvette, the reaction mixture was cooled to 35° C. by means of a short Liebig condenser.

After the water of reaction had been removed, the crude product was once again pumped through the glass cuvette as above and exposed again to microwave radiation. After xylene, excess dimethylaminopropylamine and water of reaction had been distilled off, N-(3-(N,N-dmethylamino)propyl)caprylamide was obtained with 92% yield. The iodine color number was 1.2.

### Example 5

### Continuous Preparation of N-(3-(N,N-Dimethylamino)Propyl) Coconut Fatty Acid Amide

With cooling and stirring, 122 g (1.2 mol) of N,N-dimethylaminopropylamine were admixed slowly with 214 g (1 mol) of molten coconut fatty acid (mixture of principally C₁₂ and C₁₄ fatty acid). After the exothermicity had abated, the ammonium salt thus obtained was pumped continuously through the glass cuvette mounted in the microwave cavity. The delivery output of the pump was adjusted such that the residence time in the cuvette and hence in the irradiation zone was about 60 seconds. Maximum cooling performance was employed with a microwave power of 200 W, and a temperature of 190° C. measured by means of an IR sensor was attained. After leaving the glass cuvette, the reaction mixture was cooled to 35° C. by means of a short Liebig condenser.

After the water of reaction had been removed, the crude product was once again pumped through the glass cuvette as above and exposed again to microwave radiation. After excess N,N-dimethylaminopropylamine and water of reaction had been distilled off, N-(3-(N,N-dimethylamino)propyl) coconut fatty acid amide was obtained with 96% yield. The iodine color number was 0.9.

### Example 6

### Continuous Preparation of N-(3-(N,N-Dimethylamino)Propyl)Lauramide

With cooling and stirring, 102 g (1 mol) of N,N-dimethylaminopropylamine were admixed slowly with 214 g (1 mol) of molten lauric acid. After the exothermicity had abated, the ammonium salt thus obtained was pumped continuously through the glass cuvette mounted in the microwave cavity. The delivery output of the pump was adjusted such that the residence time in the cuvette and hence in the irradiation zone was about 70 seconds. Maximum cooling performance was employed with a microwave power of about 200 W, and a temperature of 195° C. measured by means of an IR sensor was attained. After leaving the glass cuvette, the reaction mixture was cooled to about 70° C. (>melting point of the product) by means of a short Liebig condenser.

After the water of reaction had been removed under reduced pressure, the crude product was once again pumped through the glass cuvette as above and exposed again to microwave radiation. After unconverted N,N-dimethylaminopropylamine and water of reaction had been distilled off, N-(3-(N,N-dimethylamino)propyl)lauramide was obtained with 94% yield. The iodine color number was 1.0.

### Example 7

### Continuous Preparation of N-(3-(N,N-Diethylamino)Propyl)Lauramide

With cooling and stirring, 133 g (1.02 mol) of N,N-diethylaminopropylamine were admixed slowly with 214 g (1 mol) of molten lauric acid. After the exothermicity had abated, the ammonium salt thus obtained was pumped continuously through the glass cuvette mounted in the microwave cavity. The delivery output of the pump was adjusted such that the residence time in the cuvette and hence in the irradiation zone was about 75 seconds. Maximum cooling performance was employed with a microwave power of about 300 W, and a temperature of 200° C. measured by means of an IR sensor was attained. After leaving the glass cuvette, the reaction mixture was cooled to about 70° C. (>melting point of the product) by means of a short Liebig condenser. Subsequently, the water of reaction was removed under reduced pressure and the crude product was pumped through the glass cuvette once again as described above and exposed again to microwave radiation with a power of 300 watts. Overall, the operation is repeated three times and, finally, all low-boiling components (principally water of reaction and N,N-diethylaminopropylamine traces) are removed by vacuum distillation. N-(3-(N,N-Diethylamino)propyl)lauramide was obtained with 98.5% yield. The iodine color number was 1.0.

### Example 8

### Preparation of N-(3-(N,N-Dimethylamino)Propyl) Coconut Fatty Acid Amide (Comparative Example)

A 1 liter three-neck flask with water separator, precision glass stirrer and dropping funnel was initially charged with 214 g (1 mol) of coconut fatty acid (mixture of principally C₁₂ and C₁₄ fatty acid) and 2 g of methanesulfonic acid as a catalyst, which were blanketed with nitrogen and heated to melting. As soon as the melt was homogeneous, 113 g (1.1 mol) of dimethylaminopropylamine were added slowly. Owing to the neutralization reaction, there was a very distinct temperature rise. As soon as the exothermic reaction had abated, the reaction mixture was heated to reflux and water of reaction was separated out. The internal temperature of the reaction mixture rose to 180-185° C. as the reaction advanced. After 15 hours, no further water of reaction was separated out and the reaction mixture was freed of excess N,N-dimethylaminopropylamine and residual water of reaction by distillation.

After cooling, 329 g of N-(3-(N,N-dimethylamino)propyl) coconut fatty acid amide (89% of theory) with an iodine color number of 7.5 were obtained.

### Example 9

### Continuous Preparation of N-(3-(N,N-Dimethylamino)Propyl)Lauramide (Comparative Example)

With cooling and stirring, 75 g of propanolamine (1 mol) were admixed slowly with 214 g (1 mol) of lauric acid at 40° C. After the exothermicity had abated, the ammonium salt thus obtained was pumped continuously via the bottom inlet through the pressure-resistant glass cuvette placed in an oil bath at 250° C. The delivery output of the pump was adjusted such that the residence time in the cuvette was about 2 minutes. The temperature measured at the overflow reached a maximum of 175° C. After leaving the glass cuvette, the reaction mixture was cooled to about 70° C. by means of a short Liebig condenser and then the water of reaction was removed under reduced pressure. Thereafter, only traces of water (<0.2%) were detected by means of Karl-Fischer titration, and then the crude product was pumped once again through the glass cuvette as described above and was exposed again to thermal energy within the interval of 2 minutes. Only a small amount of lauric acid propanolamide of about 4% was detected in the reaction product. Owing to the very low conversion, no by-products could be identified in the ¹H NMR spectrum.

After the reaction sequence employed, the reaction mixture possessed an iodine color number of 5.9.

1. A process for preparing a basic fatty acid amide comprising the steps of reacting at least one amine which contains at least one primary or secondary amino group and at least one tertiary amino group with at least one fatty acid to give an ammonium salt, and subsequently converting this ammonium salt further under microwave irradiation to the basic amide.

2. The process as claimed in claim 1, wherein the fatty acid comprises a hydrocarbon radical having 1 to 50 carbon atoms.

3. The process as claimed in claim 2, wherein the fatty acid comprises an aliphatic hydrocarbon radical having 6 to 30 carbon atoms.

4. The process as claimed in claim 1, wherein the hydrocarbon radical of the fatty acid comprises at least one substituent selected from the group consisting of: halogen atoms, halogenated alkyl radicals, cyano, hydroxyalkyl, hydroxyl, methoxy, nitrile, nitro and sulfonic acid groups.

5. The process as claimed in claim 2, wherein the hydrocarbon radical of the fatty acid is saturated.

6. The process as claimed in claim 2, wherein the hydrocarbon radical of the fatty acid comprises at least one double bond.

7. The process as claimed in claim 1, wherein the fatty acid is selected from the group consisting of: octanoic acid, decanoic acid, dodecanoic acid, tridecanoic acid, tetradecanoic acid, 12-methyltridecanoic acid, pentadecanoic acid, 13-methyltetradecanoic acid, 12-methyltetradecanoic acid, hexadecanoic acid, 14-methylpentadecanoic acid, heptadecanoic acid, 15-methylhexadecanoic acid, 14-methylhexadecanoic acid, octadecanoic acid, isooctadecanoic acid, eicosanoic acid, docosanoic acid, tetracosanoic acid, myristoleic acid, palmitoleic acid, hexadecadienoic acid, delta-9-cis-heptadecenoic acid, oleic acid, petroselic acid, vaccenic acid, linoleic acid, linolenic acid, gadoleic acid, gondoleic acid, eicosadienoic acid, arachidonic acid, cetoleic acid, erucic acid, docosadienoic acid, tetracosenoic acid, ricinoleic acid, tall oil fatty acid, resin acids and naphthenic acids.

8. The process as claimed in claim 1, wherein the amine contains a primary amino group.

9. The process as claimed in claim 1, wherein the amine contains three or more amino groups, of which at least one is primary, at least one is secondary and at least one is tertiary.

10. The process as claimed in claim 1, in which the amine corresponds to the formula
HNR¹-(A)ₙ-Z
wherein
R¹ is hydrogen, C₁-C₁₂-alkyl, C₅-C₁₂-cycloalkyl, C₆-C₁₂-aryl, C₇-C₁₂-aralkyl or a heteroaromatic group having 5 to 12 ring members,
A is an alkylene radical having 1 to 12 carbon atoms, a cycloalkylene radical having 5 to 12 ring members, an arylene radical having 6 to 12 ring members or a heteroarylene radical having 5 to 12 ring members,
n is 0 or 1,
Z is a group of the formula —NR²R³ or a nitrogen-containing cyclic hydrocarbon radical having at least 5 ring members and
R², R³ are each independently C₁- to C₂₀-hydrocarbon radicals.

11. The process as claimed in claim 1, wherein the microwave irradiation is performed in the presence of a dehydrating catalyst.

12. The process as claimed in claim 1, wherein the microwave irradiation is performed in the presence of a solvent.

13. The process as claimed in claim 12, wherein the solvent has a dielectric loss value of less than 10.

14. The process as claimed in claim 1, wherein the microwave irradiation is performed at temperatures below 300° C.

15. The process as claimed in claim 1, wherein the reaction is performed at pressures between 0.1 and 200 bar.

16. The process as claimed in claim 1, wherein the reaction is effected continuously by irradiating with microwaves in a reaction tube through which the ammonium salt flows.

17. The process as claimed in claim 16, wherein the reaction tube consists of a nonmetallic microwave-transparent material.

18. The process as claimed in claim 16, wherein the residence time of the reaction mixture in the reaction tube is less than 30 minutes.

19. The process as claimed in claim 16, wherein the reaction tube has a ratio of length to diameter of at least 5.
